(19) United States
(12) Patent Application Publication
(10) Pub. No.: US 2019/0126668 A1
(43) Pub. Date: May 2, 2019

(54) STRAINER, STRAINER SYSTEM, AND RELATED METHODS

(71) Applicants: Shane L. Smith, Bellbrook, OH (US); Thomas Shane Springer, Pittsburg, PA (US); David A. Pavlik, Hudson,, OH (US)

(72) Inventors: Shane L. Smith, Bellbrook, OH (US); Thomas Shane Springer, Pittsburg, PA (US); David A. Pavlik, Hudson,, OH (US)

(73) Assignee: EZ Strain, LLC, Bellbrook, OH (US)

(21) Appl. No.: 16/177,245

(22) Filed: Oct. 31, 2018

Related U.S. Application Data
(60) Provisional application No. 62/581,022, filed on Nov. 2, 2017.

(51) Int. Cl. B44D 3/10

(52) U.S. Cl. CPC B44D 3/10; B01D 29/055

(57) ABSTRACT

A strainer adapted for releasable engagement with an open top of a can or container is described. The strainer includes an open ring member and a spout integrally formed therewith. Also described is a strainer system using the strainer and a mesh material. Various methods of use are also described.

### CROSS REFERENCES TO RELATED APPLICATIONS

This application claims priority upon U.S. provisional application Ser. No. 62/581,022 filed Nov. 2, 2017.

### FIELD

The present subject matter relates to strainers that are engageable with an open top of a paint can. The subject matter also relates to strainer systems using the noted strainer with one or more mesh materials. The subject matter additionally relates to various methods using the strainers and strainer systems.

### BACKGROUND

Numerous accessories are known for attachment to paint cans including strainers and pouring devices. Although satisfactory in many respects, a need remains for an improved apparatus and system to facilitate straining and pouring of paint from a can, which can be used with paint cans from multiple manufacturers, accounting for slight dimensional differences between paint can sizes.

### SUMMARY

The difficulties and drawbacks associated with previous approaches are addressed in the present subject matter as follows.

In one aspect, the present subject matter provides a strainer adapted to releasably engage an open top of a paint can. The strainer comprises a ring member having a generally circular perimeter and defining a top face and an oppositely directed bottom face. The ring member includes a ridge extending from the bottom face. In certain versions, the ridge has particularly configured fins which flex when pressed into a paint lid groove of the can. This allows for a tight fit into the paint lid groove of different paint can manufacturers, which accounts for slightly different dimensional tolerances. The ring member also defines an open region providing access between the top face and the bottom face. The strainer also comprises a spout extending from the ring member and extending radially outward from the perimeter of the ring member and upwardly from the top face of the ring member. The spout is integrally formed with the ring member.

In another aspect, the present subject matter provides a strainer system comprising a strainer including a ring member having a generally circular perimeter and defining a top face and an oppositely directed bottom face. The ring member includes a ridge extending from the bottom face. In certain versions of the strainer, the ridge of the ring member has particularly configured fins which flex when pressed into a paint lid groove. This allows for a tight fit into the paint lid groove of different paint can manufacturers, which accounts for slightly different tolerances. The ring member also defines an open region providing access between the top face and the bottom face. The strainer also includes a spout extending from the ring member and extending radially outward from the perimeter of the ring member and upwardly from the top face of the ring member. The spout is integrally formed with the ring member. The strainer system also comprises a mesh material.

In yet another aspect, the present subject matter provides a method of dispensing paint from a paint can and capturing particles, dirt or debris contained in the paint. The method comprises providing a strainer including a ring member having a generally circular perimeter and defining a top face and an oppositely directed bottom face. The ring member also includes a ridge extending from the bottom face. As previously noted, the ridge of the ring member may include particularly configured fins which flex when pressed into a paint lid groove. This allows for a tight fit into the paint lid groove of different paint can manufacturers, which accounts for slightly different tolerances. The ring member also defines an open region providing access between the top face and the bottom face. The strainer also includes a spout extending from the ring member and extending radially outward from the perimeter of the ring member and upwardly from the top face of the ring member. The spout is integrally formed with the ring member. The method also comprises positioning a mesh material over an open top of the paint can. The method additionally comprises engaging the ridge of the strainer with the open top of the paint can such that the mesh material is disposed between the open top of the paint can and the strainer. And, the method comprises pouring paint from the paint can through the strainer whereby any particles, dirt, or debris contained in the paint are captured in the mesh material.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a top perspective view of an embodiment of a strainer in accordance with the present subject matter.

FIG. 2 is a bottom perspective view of an embodiment of a strainer in accordance with the present subject matter.

FIG. 3 is an exploded view of a strainer system in accordance with the present subject matter.

FIG. 4 is a perspective cross sectional view of the strainer of FIGS. 1 and 2.

FIG. 5 is a detailed cross sectional view showing a releasable engagement configuration between the strainer and an open top of a paint can.

### DETAILED DESCRIPTION OF THE EMBODIMENTS

The present subject matter provides a strainer device that can be attached to an open top rim or face of a conventional paint can. When a user then pours paint from the can, the paint flows through the strainer. The strainer also includes a pour spout for directing paint when pouring from the can.

More specifically, the strainer is configured to fittingly engage the top configuration of an open paint can. The strainer has a large opening extending across its face. In many applications, the strainer is used to strain or filter particles in paint such as dried flakes of paint or dirt/debris. A user places a sheet of mesh or filter media across the open top of a paint can, and then engages the strainer onto the open top of the paint can, thereby engaging and holding the mesh in between the strainer and the paint can.

The user then pours paint from the can into a tray or other receptacle. The mesh prevents particles/dirt/debris from flowing with the paint, and instead captures the particles/dirt/debris.

After pouring, the user removes the strainer and mesh. The mesh can be discarded and possibly reused, and the strainer washed/cleaned and reused.

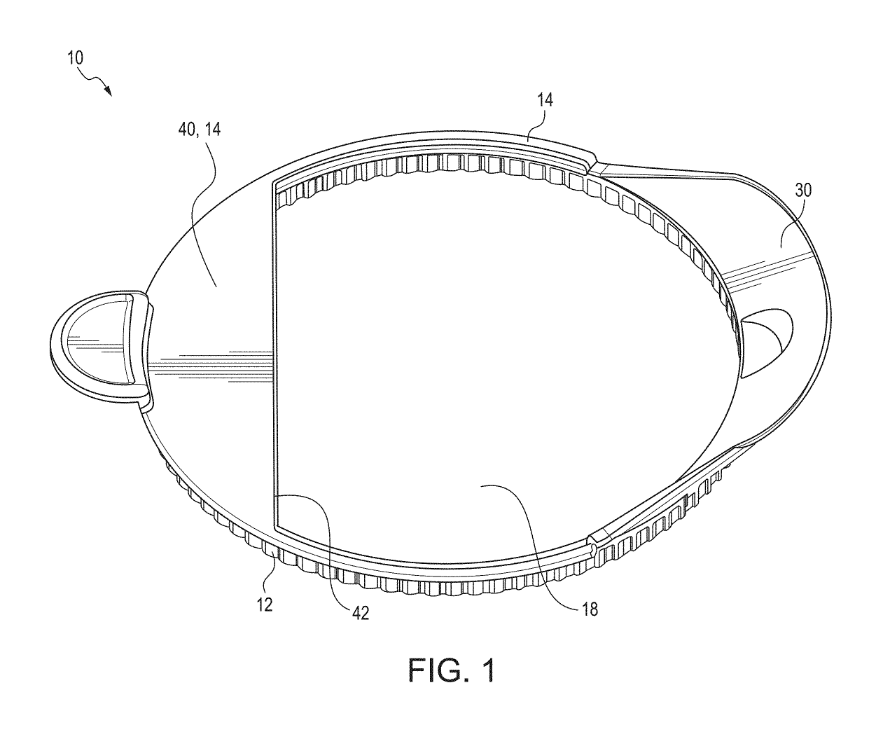

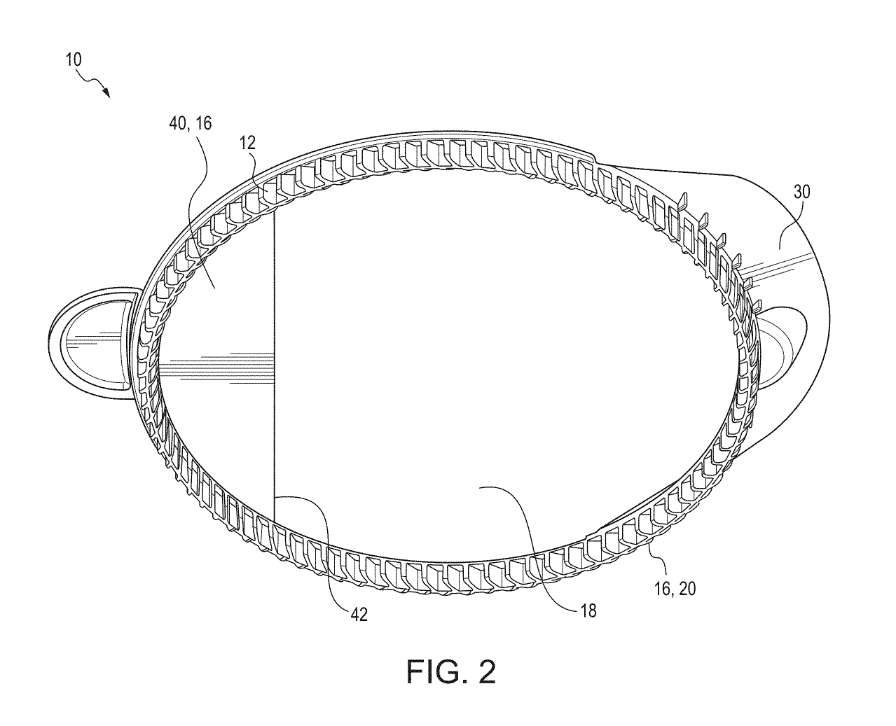

FIGS. 1 and 2 illustrate a strainer 10 in accordance with the present subject matter. The strainer 10 includes a ring member 12 having a generally circular perimeter and defining a top face 14 and an oppositely directed bottom face 16. The ring 12 includes a ridge 20 extending axially from the bottom face of the ring 12. The ring 12 also includes a plurality of projecting fins 22. The fins 22 are flexible. Each of the fins 22 generally projects laterally outward from the ridge 20. In certain embodiments, each of the fins 22 projects radially outward or at an angle of from about 20° to about 80° with respect to a radial line extending through the ridge 20. These configurations for the fins 22 promote engagement of the strainer 10 with a paint can. Thus, the flexible fin ridge 20 is sized and shaped to releasably engage a receiving region extending along an open top of a paint can as described in greater detail herein. The ring 12 also defines an open region 18 providing access between the top and bottom faces 14, 16 of the ring 12. The ring 12 also includes a pour spout 30 extending from the ring 12. In many versions, the pour spout 30 extends radially outward from the perimeter of the ring 12, and extends upwardly from the top face 14 of the ring 12. Generally, the spout 30 is integrally formed with the ring 12, such as by molding. In certain versions of the strainer 10 such as the version shown in the referenced figures, the spout 30 extends around a minority proportion of the circumference of the ring member 12, for example less than 180°. For example, in such versions, the spout 30 extends along a portion of the circumference of the ring member 12 within a range of from about 10° to about 180° and more particularly from about 30° to about 120°. It will be understood that the present subject matter is not limited to such spout configurations and includes spouts that extend more than 180° about the circumference of the ring member 12.

In particular versions of the strainer 10, the ring 12 includes a panel 40 extending across a portion of the generally circular perimeter of the ring 12. In certain embodiments, the panel 40 defines a relatively straight linear edge 42 that borders or is immediately adjacent to the open region 18.

The strainer 10 may optionally comprise one or more handles or gripping members 50. The handle(s) 50 typically extend laterally outward from the ring 12 and facilitate handling of the strainer 10 by a user. It will be understood that the present subject matter includes strainers 10 free of handles or like members.

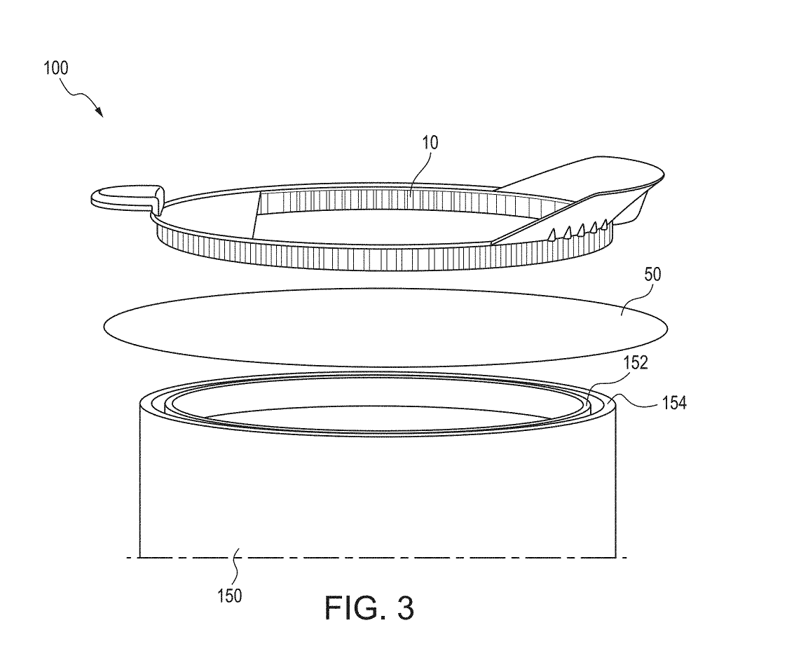

FIG. 3 is an exploded view of a strainer system 100 in accordance with the present subject matter. The strainer system 100 includes a strainer such as the previously described strainer 10 and one or more mesh or filter materials shown in FIG. 3 as mesh material 50. FIG. 3 also shows a paint can 150 having an open top face 154 that defines a recessed receiving region 152 extending along the generally circular face 154 of the can 150. As will be understood, the receiving region 152 is sized and shaped to fittingly engage a mating ridge or projection of a paint can lid as known in the art.

A wide array of mesh materials can be used for the mesh 50. A representative non-limiting example of such a mesh material is a flexible woven fabric such as fabric commercially available under the designation Basic Tulle from Jo-Ann Stores LLC. It will be appreciated that the present subject matter includes the use of other materials such as nonwoven fibrous materials, multilayered woven and nonwoven materials, paper-based materials, and composite materials which are sufficiently permeable to allow liquid flow therethrough yet provide a filtering function as described herein. Nylon and polyester are typically used for mesh materials.

The mesh typically includes a plurality of openings, apertures, or other passages across its thickness that enable the paint or other flowable material of interest to flow through the mesh, yet capture particulates such as dried paint particles or dirt along the mesh. Typical dimensions for the mesh openings are within a range of from about 500 microns to about 2,000 microns. However, it will be understood that the present subject matter includes mesh material having openings smaller than 500 microns and/or larger than 2,000 microns.

Typically, the mesh material 50 is in the form of a flexible sheet or a planar member. Nonlimiting thickness examples for the mesh material are within a range of from about 0.1 inch to about 0.25 inch. However, the present subject matter includes mesh materials having thicknesses outside of this representative range. Typically, the mesh material 50 is separate from the strainer 10 and not attached or formed therewith.

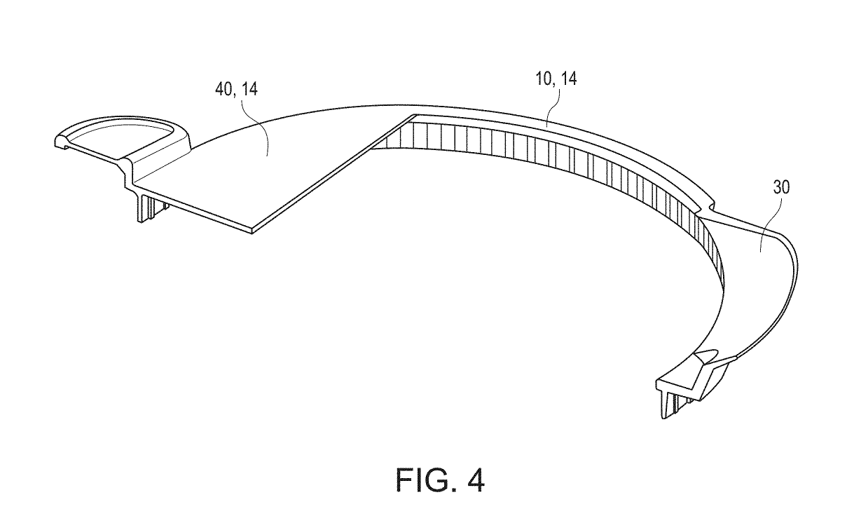

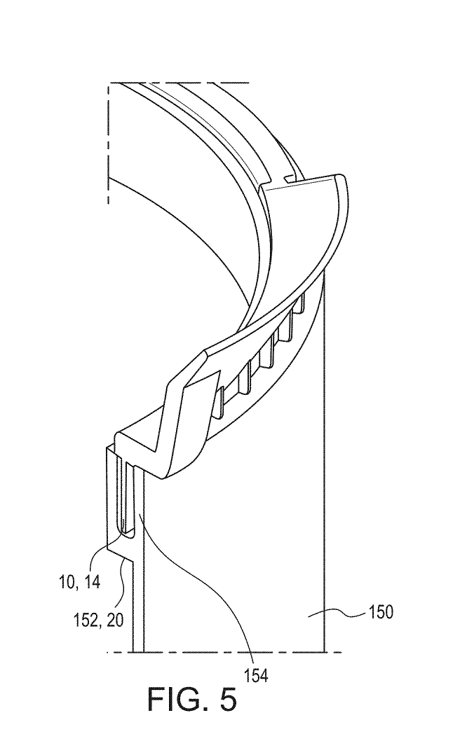

FIG. 4 is a perspective cross sectional view of the strainer 10 of FIGS. 1 and 2. And, FIG. 5 is a detailed schematic cross sectional view showing a releasable engagement configuration between the strainer 10 and the open top 154 of the paint can 150. FIG. 5 depicts the flexible fin ridge 20 of the strainer 10 fittingly engaged within the receiving region 152 of the can 150. Specifically, upon engagement of the strainer 10 in the recessed receiving region 152 extending along the open top 154 of the paint can 150; the ridge 20 is disposed in the receiving region 152. In addition, the fins 22 or at least a portion of the fins 22 are also disposed in the receiving region 152. As noted, in order to position the fins 22 in the receiving region 152, the fins 22 are flexed or otherwise deformed from their initial un-stressed positions. Such deflection of the fins 22 when the fins 22 are disposed in the receiving region 152 promotes engagement of the strainer 10 with the paint can 150.

The strainer can be formed from a wide array of materials including but not limited to metals, polymeric materials, paper-based materials, and composite materials. In many versions of the present subject matter, the strainer is formed from a moldable polymeric material such as for example polyethylene or polypropylene.

The present subject matter also provides strainer systems comprising the strainer in combination with one or more mesh materials. Generally, the mesh material is in the form of a flexible thin layer and is positioned between an open top of a paint can and the bottom face of the strainer. Upon engagement of the strainer with the paint can, the mesh material is retained between the noted components.

The present subject matter also provides methods of dispensing paint from a paint can, and straining or capturing particles, dirt, or debris contained in the paint. Generally, a method of dispensing paint from a paint can and capturing particles, dirt or debris contained in the paint is performed as follows. A strainer is provided which includes a ring member having a generally circular perimeter and defining a top face and an oppositely directed bottom face. The ring member includes a ridge extending axially from the bottom face. The ring member also includes a collection of outwardly projecting, and more particularly laterally projecting, flexible fins. The fins flex when pressed into the paint lid groove. This allows for a tight fit into the paint lid groove of different paint can manufacturers, which accounts for slightly different dimensional tolerances. The ring member also defines an open region providing access between the top face and the bottom face. The strainer also includes a spout extending from the ring member and extending radially outward from the perimeter of the ring member and upwardly from the top face of the ring member. The spout is integrally formed with the ring member. The method also comprises positioning a mesh material over an open top of the paint can and between the strainer and the paint can. And, the method additionally comprises engaging the flexible, fin ridge of the strainer with the open top of the paint can such that the mesh material is disposed between the open top of the paint can and the strainer. The method then involves pouring paint from the paint can through the strainer whereby any particles, dirt, or debris contained in the paint are captured in the mesh material. As will be appreciated, during the pouring, the paint contacts the spout and is directed away from the paint can.

The strainers, strainer systems, and methods of the present subject matter can be used with a variety of different can and container shapes, sizes, and configurations. In the description herein and referenced figures, the can is a paint can as commonly sold and commercialized in the US. Typically, such paint cans are 7.5 inches in height, and 6.5 inches in diameter, and are rated for retaining one (1) US gallon. It will be understood that the present subject matter is not limited to use with such cans and instead can be used with a wide array of other cans and containers.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A strainer adapted to releasably engage an open top of a paint can, the strainer comprising:
a ring member having a generally circular perimeter and defining a top face and an oppositely directed bottom face, the ring member including a ridge extending from the bottom face, the ridge sized and shaped to releasably engage a receiving region extending along an open top of a paint can, the ring member also defining an open region providing access between the top face and the bottom face;
a spout extending from the ring member and extending radially outward from the perimeter of the ring member and upwardly from the top face of the ring member, the spout integrally formed with the ring member.

2. The strainer of claim 1 wherein the ring member further includes a panel extending across a portion of the generally circular perimeter of the ring member.

3. The strainer of claim 2 wherein the panel defines a linear edge immediately adjacent to the open region defined by the ring member.

4. The strainer of claim 1 wherein the strainer includes at least one polymeric material.

5. The strainer of claim 1 wherein the ring member further includes a plurality of outwardly projecting fins.

6. The strainer of claim 5 wherein the plurality of fins project radially outward from the ring member.

7. The strainer of claim 1 wherein the spout extends around a minority proportion of the circumference of the ring member.

8. A strainer system comprising:
a strainer including (i) a ring member having a generally circular perimeter and defining a top face and an oppositely directed bottom face, the ring member including a ridge extending from the bottom face, the ridge sized and shaped to releasably engage a receiving region extending along an open top of a paint can, the ring member also defining an open region providing access between the top face and the bottom face, and (ii) a spout extending from the ring member and extending radially outward from the perimeter of the ring member and upwardly from the top face of the ring member, the spout integrally formed with the ring member;
a mesh material.

9. The strainer system of claim 8 wherein the ring member further includes a panel extending across a portion of the generally circular perimeter of the ring member.

10. The strainer system of claim 8 wherein the panel defines a linear edge immediately adjacent to the open region defined by the ring member.

11. The strainer system of claim 8 wherein the strainer includes at least one polymeric material.

12. The strainer system of claim 8 wherein the mesh material is a woven fabric.

13. The strainer system of claim 8 wherein the ring member further includes a plurality of outwardly projecting fins.

14. The strainer system of claim 13 wherein the plurality of fins project radially outward from the ring member.

15. The strainer system of claim 8 wherein the spout extends around a minority proportion of the circumference of the ring member.

16. A method of dispensing paint from a paint can and capturing particles, dirt or debris contained in the paint, method comprising:
providing a strainer including (i) a ring member having a generally circular perimeter and defining a top face and an oppositely directed bottom face, the ring member including a ridge extending from the bottom face, the ridge sized and shaped to releasably engage a receiving region extending along an open top of a paint can, the ring member also defining an open region providing access between the top face and the bottom face, and (ii) a spout extending from the ring member and extending radially outward from the perimeter of the ring member and upwardly from the top face of the ring member, the spout integrally formed with the ring member;
positioning a mesh material over an open top of the paint can;
engaging the ridge of the strainer with the open top of the paint can such that the mesh material is disposed between the open top of the paint can and the strainer;
pouring paint from the paint can through the strainer whereby any particles, dirt, or debris contained in the paint are captured in the mesh material.

17. The method of claim 16 wherein during the pouring, the paint contacts the spout and is directed away from the paint can.
